(19) United States
(12) Patent Application Publication
(10) Pub. No.: US 2025/0376124 A1
(43) Pub. Date: Dec. 11, 2025

(54) VEHICLE BODY STRUCTURE

(71) Applicant: TOYOTA JIDOSHA KABUSHIKI KAISHA, Aichi-ken (JP)

(72) Inventors: Shota KATO, Okazaki-shi (JP); Yoshitomo YOSHIZAWA, Chigasaki-shi (JP)

(21) Appl. No.: 19/218,371

(22) Filed: May 26, 2025

(30) Foreign Application Priority Data
Jun. 10, 2024 (JP) 2024-093569

(51) Int. Cl. B60R 19/34

(52) U.S. Cl. CPC B60R 19/34

(57) ABSTRACT

A vehicle front structure is provided including left and right front side members extending in a vehicle front-and-rear direction, and a bumper reinforcement connected to front ends of the front side members, and extending in a vehicle width direction, the vehicle front structure further including first brackets and second brackets attached to the bumper reinforcement and protruding toward a vehicle front side and a vehicle downward side in relation to the bumper reinforcement, and first bumper brackets and second bumper brackets fastened to the bumper reinforcement, and that have tips which are in contact with respective rear ends of the first brackets, and the second brackets.

### CROSS REFERENCE TO RELATED APPLICATION

This application claims priority to Japanese Patent Application No. 2024-93569 filed on Jun. 10, 2024, which is incorporated herein by reference in its entirety including the specification, claims, drawings, and abstract.

### TECHNICAL FIELD

The present disclosure relates to a vehicle body structure, and in particular to a vehicle body structure having a bumper reinforcement.

### BACKGROUND

JP 2007-69736 A discloses a bumper support structure in a case where a height of a rear side member of a vehicle and a height of a bumper reinforcement of the vehicle differ from each other. In the structure disclosed in JP 2007-69736 A, a rotation prevention joint is disposed between an end, in a vehicle rear side, of the rear side member, and a base of the bumper reinforcement, so as to prevent toppling of the base of the bumper reinforcement.

JP 2005-104264 A relates to a vehicle front structure. JP 2005-104264 A discloses a structure in which an impact absorbing member which protrudes toward a vehicle front side is disposed at a lower part of the bumper reinforcement, along a vehicle width direction.

JP 2013-203304 A relates to a bumper structure of a vehicle, and discloses a structure in which a bumper absorber is attached on a front surface of a bumper beam. In recent years, pendulum tests are performed, simulating a case in which a vehicle collides at a low velocity from a rear side of another vehicle having a relatively low vehicle height, and in which a colliding body is collided at a low position and at a low velocity. In the case of vehicles having a relatively high vehicle height such as SUVs, there has been a problem in that the colliding body moves below the bumper during the pendulum test, and a distance of ingression of the colliding body thus becomes long.

As a countermeasure, a configuration may be considered in which the entirety of the bumper reinforcement is expanded in width in a downward direction. However, during a front-collision test at a high velocity, unexpected deformation such as longitudinal bending deformation may occur in the side member, and the absorption of the impact energy may become insufficient. Further, in this case, another problem occurs in that a weight of the bumper reinforcement is increased.

An advantage of the present disclosure lies in suppression of the distance of ingression of the colliding body which ingresses at a low position at a low velocity.

### SUMMARY

According to one aspect of the present disclosure, there is provided a vehicle body structure comprising: left and right skeletal members that are disposed respectively on left and right sides of a vehicle, and that extend in a vehicle front-and-rear direction; and a bumper reinforcement that is connected to an end, on one side in the vehicle front-and-rear direction, of each of the skeletal members, and that extends in a vehicle width direction, wherein the bumper reinforcement comprises a plurality of load receiving portions which protrude toward an outer side in the vehicle front-and-rear direction, and downward in a vehicle up-and-down direction.

With this configuration, the distance of ingression of the colliding body which ingresses at a low position with a low velocity can be suppressed, while suppressing an increase in the weight as compared to a case in which the entirety of the bumper reinforcement is expanded in the width in the downward direction.

In the vehicle body structure according to another aspect of the present disclosure, the plurality of load receiving portions may include a plurality of first receiving portions disposed at positions which do not overlap the left and right skeletal members when viewed in the vehicle front-and-rear direction.

With this configuration, a longitudinal bending moment which is applied from the first receiving portion protruding in the vehicle downward direction to the left and right skeletal members can be suppressed during the front collision test at high velocity, and, thus, the longitudinal bending deformation of the left and right skeletal members can be suppressed.

In the vehicle body structure according to another aspect of the present disclosure, the plurality of load receiving portions may include left and right second receiving portions disposed at positions respectively overlapping the left and right skeletal members when viewed in the vehicle front-and-rear direction.

With this configuration, the distance of ingression of the colliding body which ingresses from a slanted front direction or from a slanted rear direction of the vehicle into a low position of the vehicle can be suppressed.

In the vehicle body structure according to another aspect of the present disclosure, the plurality of first receiving portions may be a plurality of first brackets which are separate members from the bumper reinforcement, and the plurality of first brackets may be attached to the bumper reinforcement, and protrude toward an outer side in the vehicle front-and-rear direction and downward in the vehicle up-and-down direction, in relation to the bumper reinforcement.

With this configuration, a rotational moment applied to the plurality of first brackets can be prevented from being transmitted to the bumper reinforcement. Because of this, unexpected deformation of the left and right skeletal members such as the longitudinal bending deformation can be prevented during the front collision test at high velocity, and, as a consequence, insufficiency of absorption of the impact energy can be suppressed. In the vehicle body structure according to another aspect of the present disclosure, the plurality of first brackets may be disposed symmetrically on left and right sides, respectively between a center in the vehicle width direction and the left and right skeletal members.

With this configuration, the distance of ingression of the colliding body which ingresses at a low position can be suppressed over a wide range in the vehicle width direction with a small number of the first brackets. Because of this, in the pendulum test in which a pendulum colliding body is collided with an offset from the front to a side, the distance of ingression of the pendulum colliding body can be suppressed with the first bracket.

The vehicle body structure according to another aspect of the present disclosure may further comprise a base member that is attached at an outer side, in the vehicle front-and-rear direction, of the bumper reinforcement, and that extends in the vehicle width direction, to connect the plurality of first brackets in the vehicle width direction, and the plurality of first brackets may be attached to the bumper reinforcement via the base member.

With this configuration, the plurality of first brackets can be attached in a short period of time.

The vehicle body structure according to another aspect of the present disclosure may further comprise a plurality of first bumper brackets that are fastened to the bumper reinforcement, and that have tips which are in contact with ends, at an inner side in the vehicle front-and-rear direction, of the plurality of first brackets.

With this configuration, the impact force in the vehicle front-and-rear direction applied from rear ends of the plurality of first brackets can be transmitted to the bumper reinforcement, and, at the same time, the rotational moment applied to the plurality of first brackets can be prevented from being transmitted to the bumper reinforcement. Because of this, the impact force from the front side or the rear side can be received by the bumper reinforcement, and, at the same time, the unexpected deformation of the left and right skeletal member such as the longitudinal ending deformation can be suppressed during the front collision test at high velocity, and, as a consequence, insufficiency of absorption of the impact energy can be suppressed.

In the vehicle body structure according to another aspect of the present disclosure, the first bracket may comprise an open-box type pocket portion which is attached at an outer side, in the vehicle front-and-rear direction, of the bumper reinforcement, and that has an inner side in the vehicle front-and-rear direction opened, and a sheet metal bulk housed in the pocket portion, and the first bumper bracket may be fastened to the bumper reinforcement, and have a tip which is in contact with an end, at an inner side in the vehicle front-and-rear direction, of the pocket portion, and an end, at an inner side in the vehicle front-and-rear direction, of the sheet metal bulk.

With this configuration, as compared with the case without the sheet metal bulk, a larger impact force can be received by the bumper reinforcement and transmitted to the left and right skeletal members, and, as a consequence, the distance of ingression of the colliding body can be further suppressed.

In the vehicle body structure according to another aspect of the present disclosure, the plurality of first receiving portions may be a plurality of first brackets which are separate members from the bumper reinforcement, the plurality of first brackets may be attached to the bumper reinforcement, and protrude toward an outer side in the vehicle front-and-rear direction, and downward in the vehicle up-and-down direction, in relation to the bumper reinforcement, the left and right second receiving portions may be left and right second brackets which are separate members from the bumper reinforcement, and the left and right second brackets may be attached to the bumper reinforcement, and protrude toward an outer side in the vehicle front-and-rear direction, and downward in the vehicle up-and-down direction, in relation to the bumper reinforcement.

With this configuration, the rotational moment applied to the plurality of first brackets and the left and right second brackets can be prevented from being transmitted to the bumper reinforcement. Thus, unexpected deformation of the left and right skeletal members such as the longitudinal bending deformation can be suppressed during the front collision test at high velocity, and, as a consequence, insufficiency of the absorption of the impact energy can be suppressed.

In the vehicle body structure according to another aspect of the present disclosure, the plurality of first brackets may be disposed symmetrically on left and right sides, respectively between a center in the vehicle width direction and the left and right skeletal members.

With this configuration, the distance of ingression of the colliding body which ingresses at a low position can be suppressed over a wide range in the vehicle width direction with a small number of the first brackets. Because of this, in the pendulum test in which the pendulum colliding body is collided with an offset from the front to the side, the distance of ingression of the pendulum colliding body can be suppressed with the first bracket.

The vehicle body structure according to another aspect of the present disclosure may further comprise a longitudinal base member that is attached at an outer side, in the vehicle front-and-rear direction, of the bumper reinforcement, and that extends in the vehicle width direction, to connect the plurality of first brackets and the left and right second brackets in the vehicle width direction, and the plurality of first brackets and the left and right second brackets may be attached to the bumper reinforcement via the longitudinal base member.

With this configuration, the plurality of first brackets and the left and right second brackets can be attached in a short period of time.

The vehicle body structure according to another aspect of the present disclosure may further comprise a plurality of first bumper brackets that are fastened to the bumper reinforcement, and that have tips which are in contact with ends, at an inner side in the vehicle front-and-rear direction, of the plurality of first brackets, and left and right second bumper brackets that are fastened to the bumper reinforcement, and that have tips which are in contact with ends, at an inner side in the vehicle front-and-rear direction, of the left and right second brackets.

With this configuration, the impact force in the vehicle front-and-rear direction, which is input from rear ends of the plurality of first brackets and rear ends of the left and right second brackets can be transmitted to the bumper reinforcement, and the rotational moment applied to the plurality of first brackets and the left and right second brackets can be prevented from being transmitted to the bumper reinforcement. Because of this, the impact force from the front side or the rear side can be received by the bumper reinforcement, and unexpected deformation of the left and right skeletal members such as the longitudinal bending deformation can be suppressed during the front collision test at high velocity, and, as a consequence, insufficiency of the absorption of the impact energy can be suppressed. Further, the impact energy of the colliding body which ingresses at a low position of the vehicle with a low velocity from a slanted front direction or a slanted rear direction of the vehicle can be received by the bumper reinforcement and the left and right skeletal members, and the distance of ingression of the colliding body can be suppressed.

In the vehicle body structure according to another aspect of the present disclosure, one or both of the first bracket and the second bracket may comprise an open-box type pocket portion which is attached at an outer side, in the vehicle front-and-rear direction, of the bumper reinforcement, and which has an inner side in the vehicle front-and-rear direction opened, and a sheet metal bulk housed in the pocket portion, and one or both of the first bumper bracket and the second bumper bracket may be fastened to the bumper reinforcement, and may have a tip which is in contact with an end, at an inner side in the vehicle front-and-rear direction, of the pocket portion, and an end, at an inner side in the vehicle front-and-rear direction, of the sheet metal bulk.

With this configuration, in comparison to the case in which the sheet metal bulk is not provided, a larger impact force can be received by the bumper reinforcement and transmitted to the left and right skeletal members, and, thus, the distance of ingression of the colliding body can be further suppressed.

In the vehicle body structure according to another aspect of the present disclosure, the plurality of first receiving portions and the left and right second receiving portions may protrude downward in the vehicle up-and-down direction to a predetermined ground height.

With this configuration, the distance of ingression of the colliding body which ingresses at a low position with a low velocity can be suppressed.

In the vehicle body structure according to another aspect of the present disclosure, the plurality of first brackets and the left and right second brackets may protrude downward in the vehicle up-and-down direction to a predetermined ground height.

With this configuration, the distance of ingression of the colliding body which ingresses at a low position at a low velocity can be suppressed.

The vehicle structure according to an aspect of the present disclosure can suppress the distance of ingression of the colliding body which ingresses at a low position at a low velocity.

### BRIEF DESCRIPTION OF DRAWINGS

Embodiment(s) of the present disclosure will be described based on the following figures, wherein:

FIG. 1 is a plan view of a vehicle front structure which is an embodiment of a vehicle body structure according to the present disclosure;

FIG. 2 is a perspective diagram of the vehicle front structure according to the embodiment of the present disclosure;

FIG. 3 is a plan view of the vehicle front structure according to the embodiment of the present disclosure, showing details of an A part shown in FIG. 1;

FIG. 4 is an elevation cross-sectional diagram of the vehicle front structure according to the embodiment of the disclosure, showing a cross section along a line B-B of FIG. 3;

FIG. 5 is a bottom view of the vehicle front structure according to the embodiment of the present disclosure, showing a cross section along a line C-C of FIG. 4;

FIG. 6 is an elevation cross-sectional diagram of the vehicle front structure according to the embodiment of the present disclosure, showing a cross section along a line D-D of FIG. 1;

FIG. 7 is a plan view showing a state in which a pendulum colliding body hits a first bracket of the vehicle front structure shown in FIG. 1;

FIG. 8 is an elevation cross-sectional diagram showing a state in which the pendulum colliding body hits the first bracket of the vehicle front structure shown in FIG. 1;

FIG. 9 is a plan view showing a state in which the pendulum colliding body hits a second bracket of the vehicle front structure shown in FIG. 1;

FIG. 10 is an elevation cross-sectional diagram showing a state in which the pendulum colliding body hits the second bracket of the vehicle front structure shown in FIG. 1;

FIG. 11 is a plan view showing a state in which a barrier ingresses the vehicle front structure shown in FIG. 1, at a high velocity;

FIG. 12 is an elevation cross-sectional diagram showing a state in which the barrier ingresses the vehicle front structure shown in FIG. 1 at a high velocity;

FIG. 13 is a plan view of another vehicle front structure which is another embodiment of a vehicle body structure according to the present disclosure;

FIG. 14 is a plan view of another vehicle front structure which is another embodiment of a vehicle body structure according to the present disclosure;

FIG. 15 is a plan view of another vehicle front structure which is another embodiment of a vehicle body structure according to the present disclosure;

FIG. 16 is an elevation cross-sectional diagram of the vehicle front structure shown in FIG. 15, showing a cross section along a line E-E of FIG. 15;

FIG. 17 is an elevation cross-sectional diagram of the vehicle front structure shown in FIG. 15, showing a cross section along a line F-F of FIG. 15; and

FIG. 18 is a plan view showing a vehicle rear structure which is another embodiment of a vehicle body structure according to the present disclosure.

### DESCRIPTION OF EMBODIMENTS

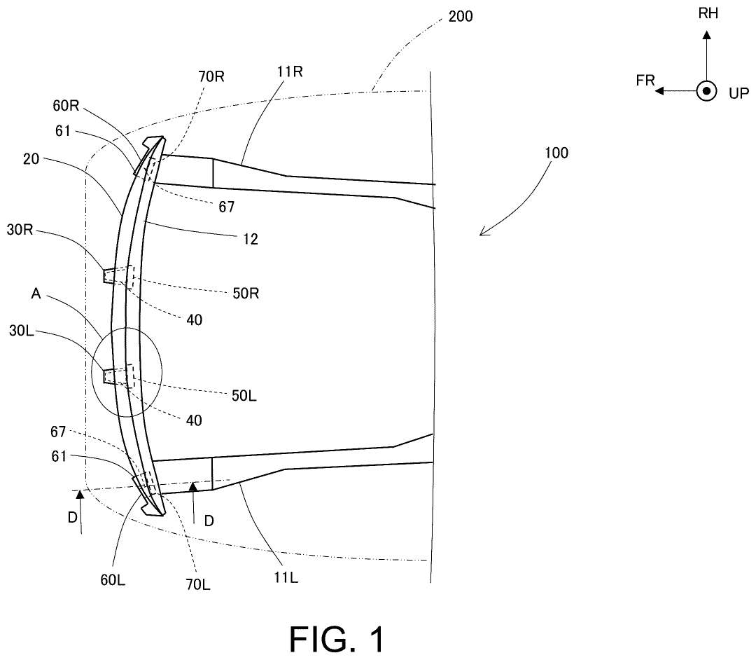

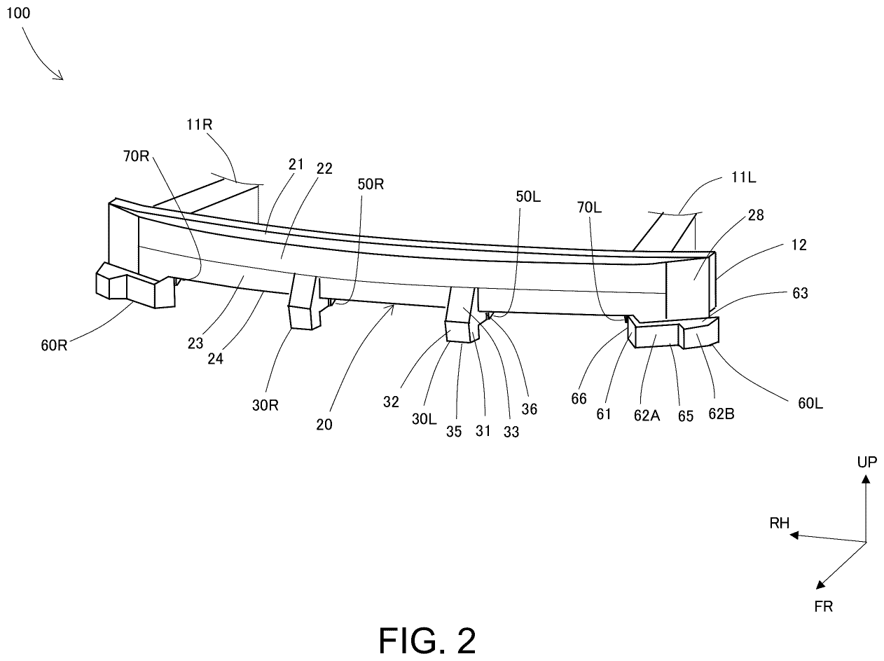

A vehicle front structure 100 which is an embodiment of a vehicle body structure according to the present disclosure will now be described with reference to the drawings. As shown in FIGS. 1 and 2, the vehicle front structure 100 comprises left and right front side members 11L and 11R, a bumper reinforcement 12, a longitudinal base member 20, a plurality of first brackets 30L and 30R, left and right second brackets 60L and 60R, a plurality of first bumper brackets 50L and 50R, and left and right second bumper brackets 70L and 70R. In the drawings, “FR”, “UP”, and “RH” respectively refer to a front side, an upper side, and a right side of a vehicle 200 having the vehicle front structure 100. Directions opposite from FR, UP, and RH respectively show a rear side, a lower side, and a left side. In the following description, unless otherwise specified, when the structure is described simply with the sides of front and rear, left and right, and upward and downward, the sides refer to the front and rear sides in a front-and-rear direction of the vehicle 200, the left and right sides in a left-and-right direction of the vehicle 200, and the upward and downward sides in an up-and-down direction of the vehicle, respectively. Further, the front and rear sides in the front-and-rear direction, the left and right sides in the left-and-right direction, and the upward and downward sides in the up-and-down direction of the vehicle 200 are also front and rear sides in a front-and-rear direction, left and right sides in a left-and-right direction, and upward and downward sides in an up-and-down direction of the vehicle front structure 100.

The left and right front side members 11L and 11R are skeletal members which are disposed at left and right sides of the vehicle 200, and which extend in the vehicle front-and-rear direction. The left and right front side members 11L and 11R may be, for example, longitudinal members having a quadrangular, closed cross section.

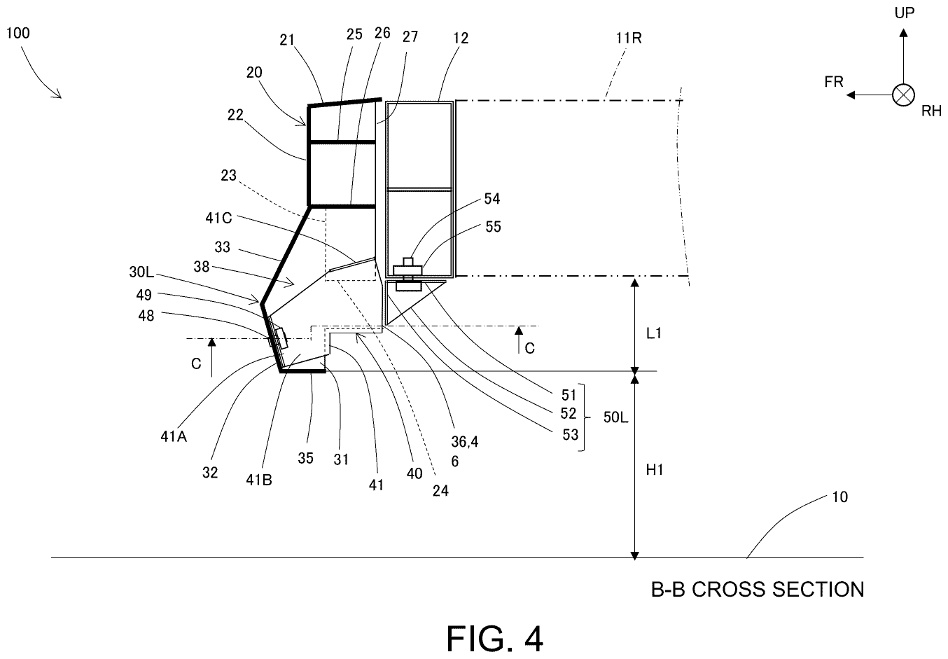

The bumper reinforcement 12 is a member which is connected to front ends of the left and right front side members 11L and 11R, and which extends in a vehicle width direction. As shown in FIG. 4, the bumper reinforcement 12 has a quadrangular, closed cross section, and a lateral rib in a width direction is provided at a center in the up-and-down direction. Here, front ends of the left and right front side members 11L and 11R are respectively ends on one side of the left and right front side members 11L and 11R. Therefore, the bumper reinforcement 12 is a member which is connected to ends, on one side in the vehicle front-and-rear direction, of the left and right front side members 11L and 11R, and which extends in the vehicle width direction.

The longitudinal base member 20 is a longitudinal member made of a resin, which is attached on a front surface of the bumper reinforcement 12 and which extends in the vehicle width direction. Here, the front surface of the bumper reinforcement 12 is a surface at an outer side, in the vehicle front-and-rear direction, of the bumper reinforcement 12. A height of the longitudinal base member 20 is approximately the same as a height of the bumper reinforcement 12, and the longitudinal base member 20 is fastened by a bolt on the front surface of the bumper reinforcement 12 in a manner to cover the front surface of the bumper reinforcement 12.

The plurality of first brackets 30L and 30R are resin members which protrude from the longitudinal base member 20 in the front side of the vehicle and in the downward direction of the vehicle. In other words, the first brackets 30L and 30R protrude from the longitudinal base member 20 toward the outer side in the vehicle front-and-rear direction and downward in the vehicle up-and-down direction. The plurality of first brackets 30L and 30R are disposed symmetrically in the left and right sides, respectively between the center in the vehicle width direction and the left and right front side members 11L and 11R. In addition, the left and right second brackets 60L and 60R are resin members which protrude respectively from left and right ends of the longitudinal base member 20 in the front side of the vehicle and in the downward direction of the vehicle. In other words, the left and right second brackets 60L and 60R protrude from the longitudinal base member 20 toward the outer side in the vehicle front-and-rear direction, and downward in the vehicle up-and-down direction.

The plurality of first bumper brackets 50L and 50R are fastened to a lower surface of the bumper reinforcement 12. The plurality of first bumper brackets 50L and 50R are stopper members having respective front ends respectively in contact with rear ends of the first brackets 30L and 30R. Similarly, the left and right second bumper brackets 70L and 70R are stopper members which are fastened to the lower surface of the bumper reinforcement 12, and having respective front ends respectively in contact with rear ends of the left and right second brackets 60L and 60R.

Next, with reference to FIGS. 2 to 6, details of the longitudinal base member 20, the first brackets 30L and 30R, the left and right second brackets 60L and 60R, the first bumper brackets 50L and 50R, and the left and right second bumper brackets 70L and 70R will be described.

As shown in FIGS. 2 to 4, the longitudinal base member 20 is a longitudinal member formed from an upper plate 21, an upper front plate 22, a lower front plate 23, and a lower plate 24, and having an approximate groove shape cross section with the vehicle rear side opened. The lower front plate 23 is disposed at a position slightly at the vehicle rear side in relation to the upper front plate 22. At the inside, there are provided lateral ribs 25 and 26 extending from the upper front plate 22 or the lower front plate 23 toward the vehicle rear side, and a longitudinal rib 27. The lateral ribs 25 and 26 and the longitudinal rib 27 partition the inside of the longitudinal base member 20 in a lattice form. The longitudinal base member 20 is a resin-molded member.

The center left first bracket 30L, disposed between the center in the vehicle width direction and the left front side member 11L, is formed from side plates 31, a front plate 32, a top plate 33, and a bottom plate 35. The left and right side plates 31 extend downward from a lower surface of the lateral rib 26 at the lower side, and respectively form left and right side surfaces of the first bracket 30L. The front plate 32 is a plate member which connects the front ends of the side plates 31 in the left-and-right direction. The top plate 33 is a plate member which connects an upper end of the front plate 32 and a lower end of the upper front plate 22. The side plates 31, the front plate 32, the top plate 33, and the bottom plate 35 forming the first bracket 30L are formed by integrally molding a resin, along with the longitudinal base member 20.

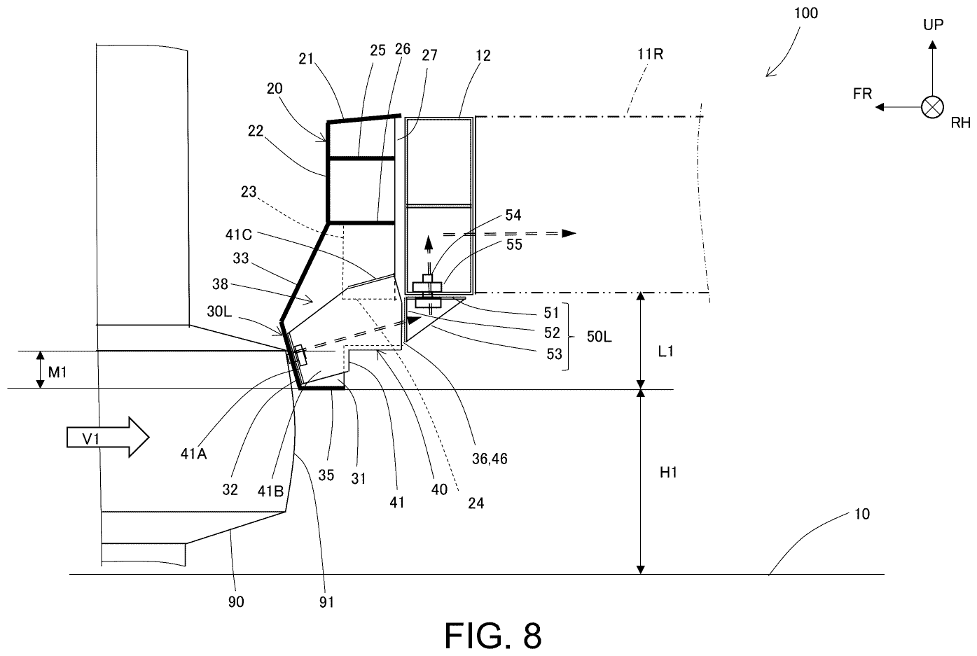

As shown in FIG. 4, lower ends of the side plates 31 of the first bracket 30L protrude from the lower surface of the bumper reinforcement 12 downward in the vehicle up-and-down direction by a length L1, in such a manner that a ground height from a road surface 10 is a predetermined height H1. The predetermined height H1 can be freely selected so long as the height allows reception of a pendulum colliding body 90 (refer to FIG. 8) to be described later, and may be, for example, between 15 inches and 20 inches (between 393.7 mm and 508 mm).

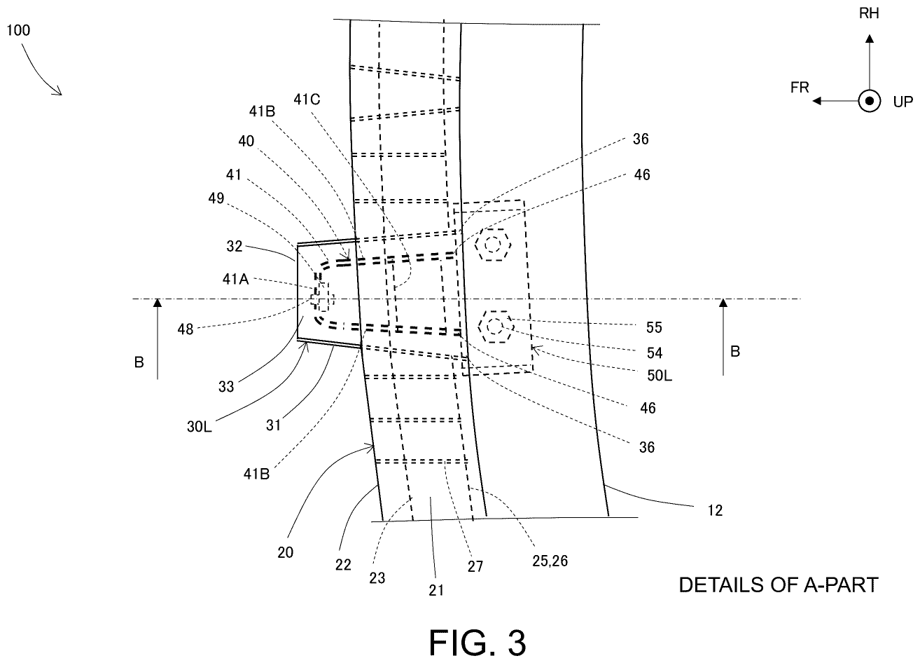

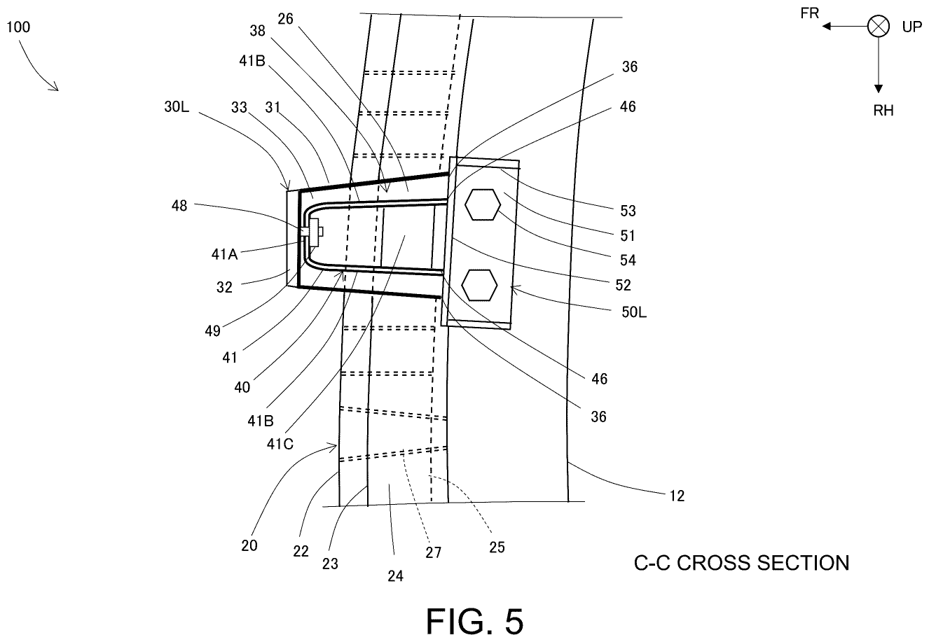

The lateral ribs 26, the left and right side plates 31, the top plate 33, the front plate 32, and the bottom plate 35 protrude from the front surface of the bumper reinforcement 12 toward the vehicle front side, and form an open-box type pocket portion 38, having the vehicle rear side opened. Rear end surfaces 36 of the left and right side plates 31 extend to the rear side up to the same plane as the front surface of the bumper reinforcement 12. A sheet metal bulk 40 is attached inside the pocket portion 38. The sheet metal bulk 40 is formed from a groove shape cross section member formed from a web 41A and flanges 41B extending upright from left and right ends of the web 41A toward the vehicle rear side, as shown in FIGS. 3 and 5, and a connection plate 41C which connects upper ends, at the rear side, of the flanges 41B, as shown in FIG. 4. The web 41A of the sheet metal bulk 40 is fixed by a pin 48 and a nut 49 to the front plate 32. Rear end surfaces 46 of the left and right flanges 41B of the sheet metal bulk 40 are on the same plane with the rear end surfaces 36 of the left and right side plates 31 of the first bracket 30L. The rear end surface 46 of the sheet metal bulk 40 and the rear end surface 36 of the side plate 31 form a rear end of the first bracket 30L.

As shown in FIGS. 4 and 5, the center left first bumper bracket 50L disposed between the center in the vehicle width direction and the left front side member 11L is formed from an L-shape member formed from a base 51 and a front flange 52, and triangular ribs 53 attached to left and right ends of the base 51 and the front flange 52. The base 51 is fastened to the lower surface of the bumper reinforcement 12 by a bolt 54 and a nut 55. When the base 51 is fastened to the lower surface of the bumper reinforcement 12, a front end surface of the front flange 52 is on the same plane as the front surface of the bumper reinforcement 12. The front end surface of the front flange 52 is in contact with the rear end surfaces 36 of the left and right side plates 31 of the first bracket 30L and the rear end surfaces 46 of the left and right flanges 41B of the sheet metal bulk 40. Therefore, the first bumper bracket 50L is configured to transmit an impact force in the vehicle front-and-rear direction, applied from the rear end surface 36 of the side plate 31 and the rear end surface 46 of the sheet metal bulk 40, to the bumper reinforcement 12, and to prevent transmission of a rotational moment applied to the first bracket 30L to the bumper reinforcement 12. Here, the rear end surface 36 of the side plate 31 and the rear end surface 46 of the sheet metal bulk 40 form an end, at an inner side in the vehicle front-and-rear direction, of the side plate 31, and an end, at an inner side in the vehicle front-and-rear direction, of the sheet metal bulk 40. Further, the front end surface of the front flange 52 forms a tip of the first bumper bracket 50L.

The center right first bracket 30R and the center right first bumper bracket 50R, disposed between the center in the vehicle width direction and the right front side member 11R, are symmetric in the left and right sides with the center left first bracket 30L and the center left first bumper bracket 50L which have already been described. Therefore, description of these members will not be repeated.

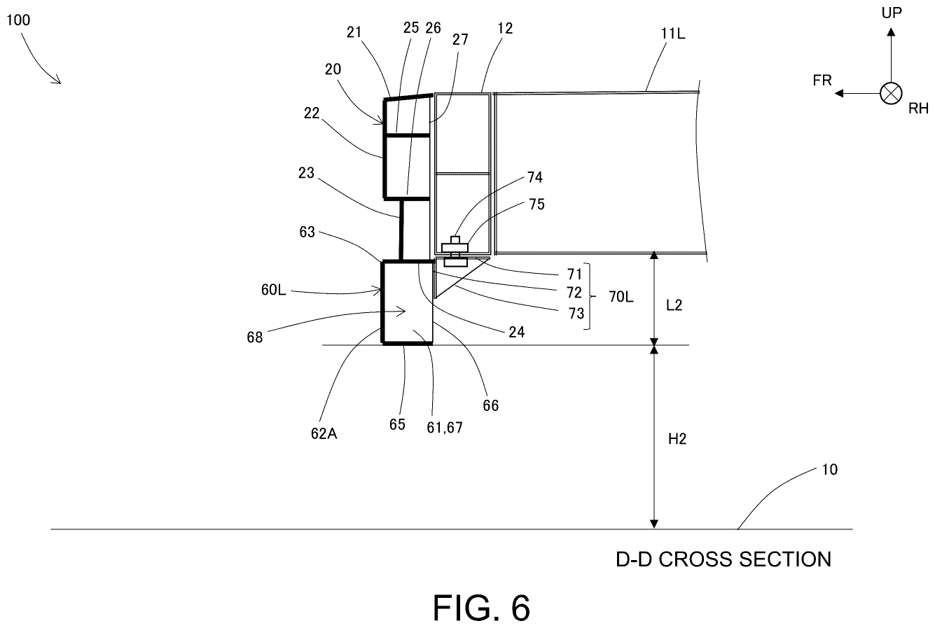

The left second bracket 60L is formed from side plates 61, a front plate 62A, a corner plate 62B, a top plate 63, and a bottom plate 65. As shown in FIG. 6, the side plates 61 extend from the lower plate 24 of the bumper reinforcement 12 toward the downward side, and form side walls, at an inner side in the vehicle width direction, of the second bracket 60L. The front plate 62A is a plate member which is connected to front ends of the side plates 61, and which extends toward the outer side in the vehicle width direction. As shown in FIG. 2, the corner plate 62B is a plate member which is bent in a groove shape, and connected to an end, at an outer side in the vehicle width direction, of the front plate 62A. The top plate 63 extends from the front end of the lower plate 24 of the bumper reinforcement 12 toward the vehicle front side, and is connected to upper ends of the side plates 61, the front plate 62A, and the corner plate 62B. The bottom plate 65 is connected to lower ends of the side plates 61, the front plate 62A, and the corner plate 62B. The side plates 61, the front plate 62A, the corner plate 62B, the top plate 63, and the bottom plate 65 protrude from the front surface of the bumper reinforcement 12 toward the vehicle front side, and form an open-box type pocket portion 68 having the vehicle rear side opened. In addition, rear end surfaces 66 of the side plates 61 extend to the rear side to the same plane as the front surface of the bumper reinforcement 12. A longitudinal rib 67 which extends from the front plate 62A toward the vehicle rear side is provided inside the pocket portion 68. A rear end surface of the longitudinal rib 67 extends toward the vehicle rear side to the same plane as the rear end surfaces 66 of the side plates 61. The rear end surface 66 of the side plate 61 and the rear end surface of the longitudinal rib 67 form a rear end of the second bracket 60L. The side plates 61, the front plate 62A, the corner plate 62B, the top plate 63, and the bottom plate 65 forming the second bracket 60L are formed by integral molding a resin, along with the longitudinal base member 20. Here, the rear end surfaces 66 of the side plates 61 and the rear end surface of the longitudinal rib 67 form ends, at an inner side in the vehicle front-and-rear direction, of the side plates 61, and an end, at an inner side in the vehicle front-and-rear direction, of the longitudinal rib 67.

As shown in FIG. 6, lower ends of the side plates 61 of the second bracket 60L protrude from the lower surface of the bumper reinforcement 12 by a length L2 downward in the vehicle up-and-down direction, in such a manner that a ground height from the road surface 10 is a predetermined height H2. Here, similar to the predetermined height H1 for the first bracket 30L described above, the predetermined height H2 may be set between 15 inches and 20 inches (between 393.7 mm and 508 mm). The predetermined height H2 may be equal to or different from the predetermined height H1.

The left second bumper bracket 70L has a structure similar to that of the first bumper bracket 50L, and is formed from a base 71, a front flange 72, and a triangular rib 73, as shown in FIG. 6. The base 71 is fastened on the lower surface of the bumper reinforcement 12 by a bolt 74 and a nut 75. When the base 71 is fastened on the lower surface of the bumper reinforcement 12, a front end surface of the front flange 72 is on the same plane as the front surface of the bumper reinforcement 12. Further, the front end surface of the front flange 72 is in contact with the rear end surfaces 66 of the side plates 61 of the second bracket 60L, and the rear end surface of the longitudinal rib 67 provided in the pocket portion 68. Therefore, similar to the first bracket 30L, the second bumper bracket 70L is configured to transmit the impact force in the vehicle front-and-rear direction, applied from the rear end of the second bracket 60L, to the bumper reinforcement 12, and to prevent transmission of the rotational moment applied to the second bracket 60L to the bumper reinforcement 12. Here, the front end surface of the front flange 72 forms a tip of the second bumper bracket 70L.

The right second bracket 60R and the right second bumper bracket 70R are symmetric on the left and right sides with the left second bracket 60L and the left second bumper bracket 70L described above. Therefore, description of these members will not be repeated.

As described, in the vehicle front structure 100 according to the embodiment of the present disclosure, the longitudinal base member 20, the center right and center left first brackets 30L and 30R, and the left and right second brackets 60L and 60R are formed by integrally molding a resin. Therefore, the longitudinal base member 20 connects the plurality of first brackets 30L and 30R and the left and right second brackets 60L and 60R in the vehicle width direction. Thus, the plurality of first brackets 30L and 30R and the left and right second brackets 60L and 60R are attached to the bumper reinforcement 12 via the longitudinal base member 20.

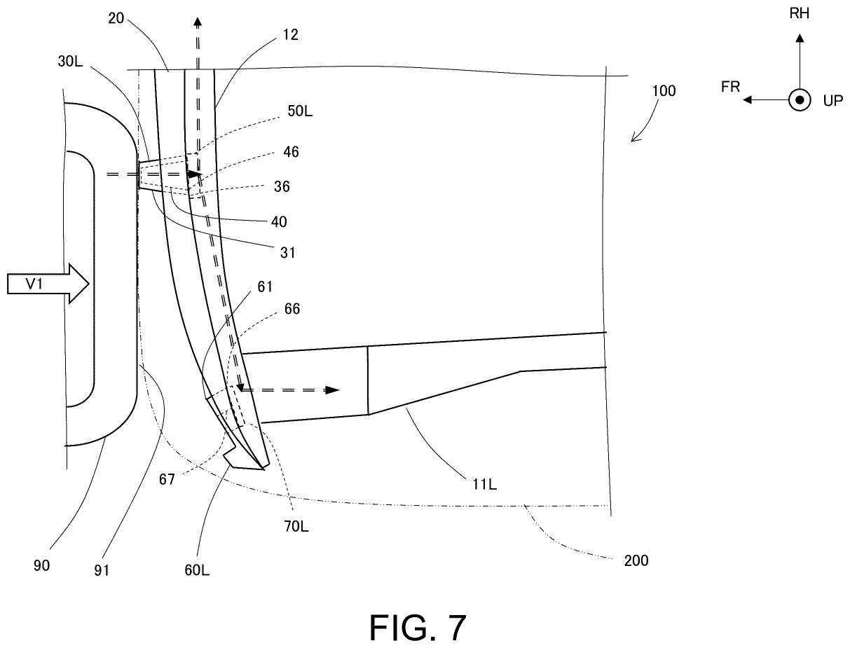

Next, with reference to FIGS. 7 to 10, a flow of the impact force when the pendulum colliding body 90 collides with the vehicle front structure 100 according to the embodiment of the present disclosure will be described.

The pendulum colliding body 90 is a colliding body which is used in a pendulum test which simulates a state in which a vehicle 200 collides with another vehicle having a low vehicle height, at a low velocity and from behind the other vehicle. As shown in FIG. 7, the pendulum colliding body 90 has a U-shaped planar shape, and, as shown in FIG. 8, a cross section of a colliding surface 91 is a curved surface.

First, with reference to FIGS. 7 and 8, a flow of the impact force when the pendulum colliding body 90 collides with the vehicle 200 at a velocity V1 and from the front side will be described. In the following description, a case as shown in FIG. 7 will be described, in which the pendulum colliding body 90 ingresses at a position which is offset to the left side from the front of the vehicle 200. Deformation when the pendulum colliding body 90 ingresses at a position which is offset to the right side from the front of the vehicle 200 is symmetric in the left and right sides as the case in which the pendulum colliding body 90 ingresses at the position which is offset to the left side from the front of the vehicle 200, and description thereof will be omitted.

As shown in FIG. 7, when the pendulum colliding body 90 collides with the vehicle 200 from the front side, the colliding surface 91 of the pendulum colliding body 90 collides with the front plate 32 of the center left first bracket 30L. During this process, as shown in FIG. 8, the pendulum colliding body 90 collides with the front plate 32 of the center left first bracket 30L with the colliding surface 91 overlapping the front plate 32 by a length M1 in the height direction.

As shown by a dotted arrow in FIG. 8, the impact force of the collision is transmitted from the front plate 32 of the center left first bracket 30L to the sheet metal bulk 40, and further, from the rear end surface 46 of the flange 41B of the sheet metal bulk 40 to the first bumper bracket 50L. As shown by a dotted arrow in FIG. 7, the impact force transmitted to the first bumper bracket 50L is transmitted through the bumper reinforcement 12, to the left and right front side members 11L and 11R. The impact force is then received by the left and right front side members 11L and 11R.

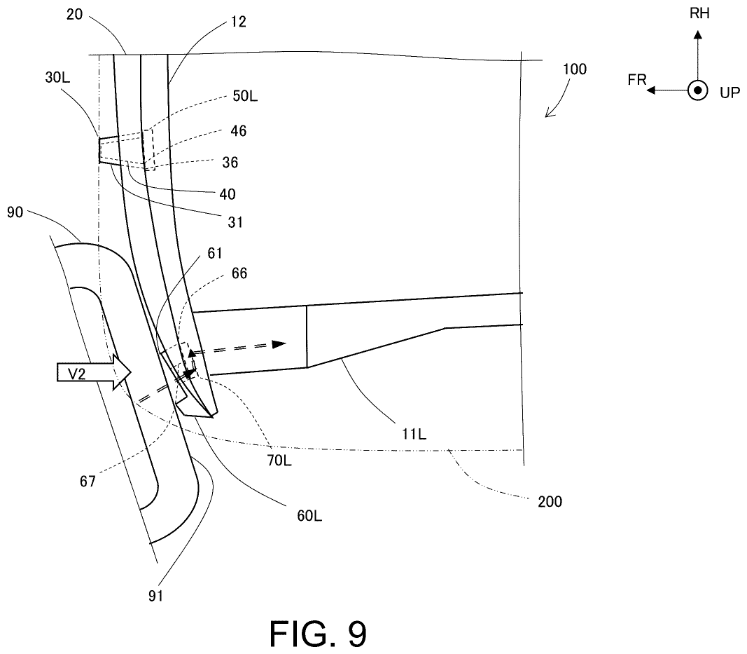

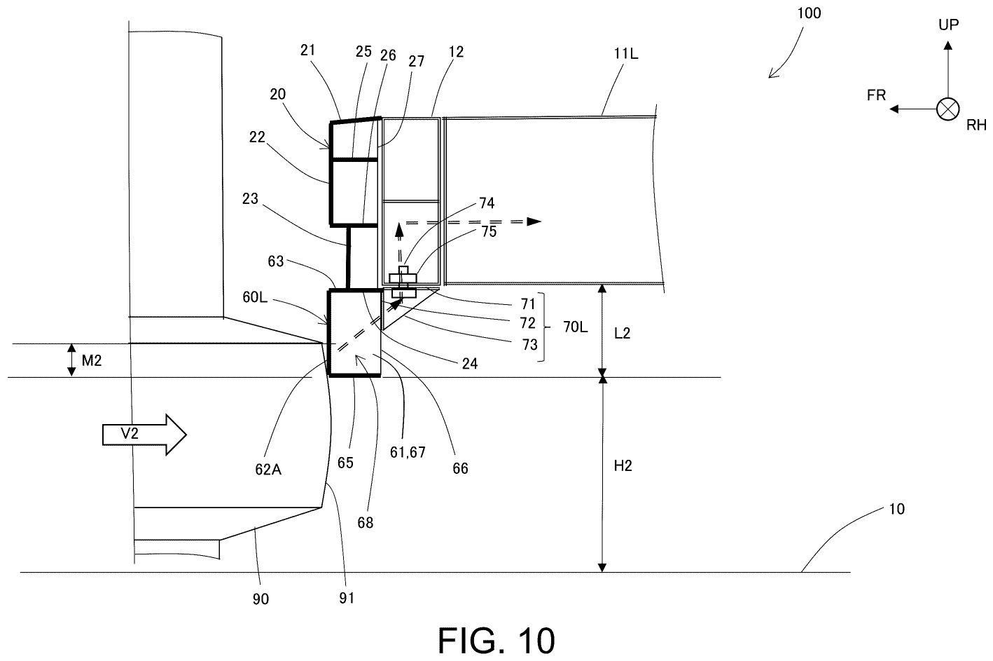

Next, with reference to FIGS. 9 and 10, a flow of the impact force when the pendulum colliding body 90 collides with the vehicle 200 at a velocity V2 from a slanted front direction will be described. The velocity V2 is less than the velocity V1 when the pendulum colliding body 90 collides from the front side, as described above.

As shown in FIG. 9, when the pendulum colliding body 90 collides with the vehicle 200 from a slanted left front direction of the vehicle 200, the colliding surface 91 of the pendulum colliding body 90 collides with the front plate 62A of the left second bracket 60L. During this process, as shown in FIG. 10, the pendulum colliding body 90 collides with the front plate 62A of the left second bracket 60L with the colliding surface 91 overlapping the front plate 62A by a length M2 in the height direction.

As shown by a dotted arrow in FIG. 10, the impact force of the collision is transmitted from the front plate 62A of the left second bracket 60L to the side plate 61 and the longitudinal rib 67 provided in the pocket portion 68, and is transmitted from the rear end surface 66 of the side plate 61 and the rear end surface of the longitudinal rib 67 to the second bumper bracket 70L. As shown by a dotted arrow in FIG. 9, the impact force transmitted to the second bumper bracket 70L is transmitted through the bumper reinforcement 12, to the left front side member 11L. The impact force is then received by the left front side member 11L.

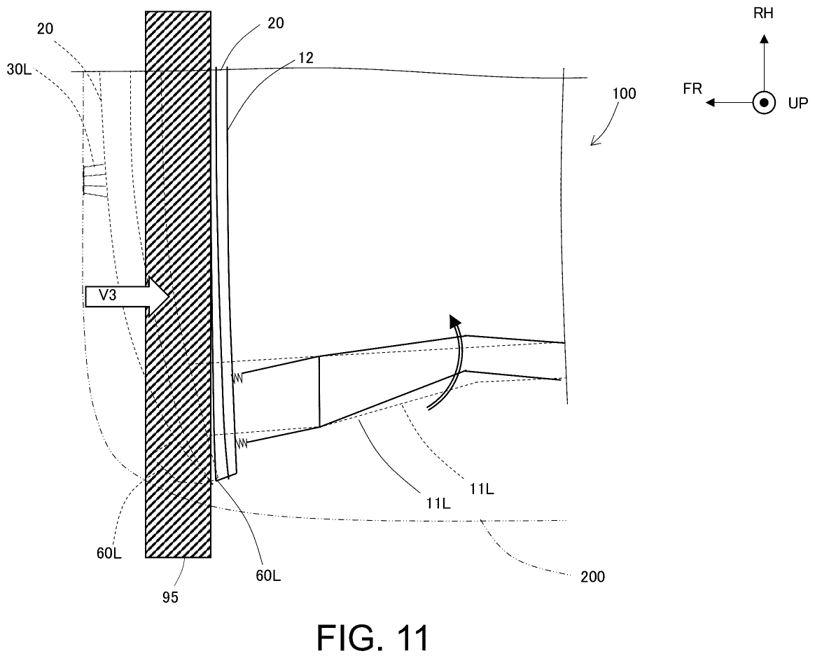

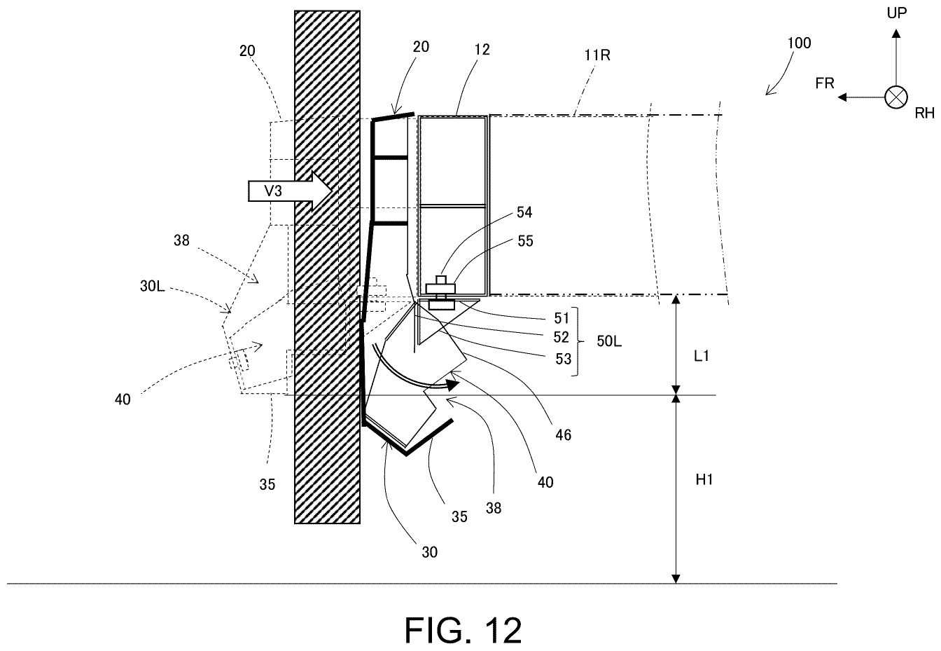

Next, with reference to FIGS. 11 and 12, deformation of the vehicle front structure 100 when a barrier 95 ingresses at a high velocity V3 from the front side of the vehicle 200 will be described. The velocity V3 is greater than the ingression velocities V1 and V2 of the pendulum colliding body 90 described above. While FIGS. 11 and 12 show the deformation of the left part of the vehicle 200, deformation of the right part of the vehicle 200 is symmetric in the left and right sides with the left part. Further, in FIGS. 11 and 12, dotted lines show a state of the barrier 95 before the collision, and solid lines show a deformed state after the barrier 95 has collided. As shown in FIGS. 11 and 12, the barrier 95 has a width greater than a total width of the vehicle front structure 100, and a height greater than a total height of the vehicle front structure 100, and collides with an entire front surface of the vehicle front structure 100.

As shown in FIG. 12, when the barrier 95 collides with the vehicle front structure 100, the barrier 95 collides with the front plate 32 of the center left first bracket 30L, and ingresses toward the vehicle rear side while collapsing the pocket portion 38 of the center left first bracket 30L. The rear end surface 46 of the sheet metal bulk 40 disposed in the pocket portion 38 is in contact with the front flange 52 of the center left first bumper bracket 50L, and the impact force in the vehicle front-and-rear direction is transmitted to the bumper reinforcement 12. However, because the sheet metal bulk 40 is configured to prevent transmission of the rotational moment to the bumper reinforcement 12, the rotational moment to rotate the sheet metal bulk 40 counterclockwise, due to the impact force, is not received by the bumper reinforcement 12. As such, when the barrier 95 ingresses, as shown by an arrow in FIG. 12, the sheet metal bulk 40 rotationally deforms counterclockwise. Thus, the rotational moment which would upwardly bend the front side member 11L, in a form of convex in the upward direction, is not input to the front side member 11L. As a result, as shown by a solid line in FIG. 11, the left front side member 11L is bent in the lateral direction toward the inner side in the vehicle width direction, due to the impact force in the vehicle front-and-rear direction.

As described, the vehicle front structure 100 according to the embodiment has the plurality of first brackets 30L and 30R, and the left and right second brackets 60L and 60R, which are attached to the bumper reinforcement 12 and which protrude to the outer side in the vehicle front-and-rear direction and downward in the vehicle up-and-down direction in relation to the bumper reinforcement 12. With this configuration, the distance of ingression of the pendulum colliding body 90 which ingresses at a low position at a low velocity from the front side or from the slanted front direction of the vehicle 200 can be suppressed, while suppressing an increase in the weight, in comparison to the case in which the entirety of the bumper reinforcement 12 is expanded in width toward the downward direction.

In addition, in the vehicle front structure 100, the plurality of first brackets 30L and 30R, and the left and right second brackets 60L and 60R are formed as separate members from the bumper reinforcement 12. Thus, the rotational moment applied to the plurality of first brackets 30L and 30R and the left and right second brackets 60L and 60R can be prevented from being transmitted to the bumper reinforcement 12. Because of this, unexpected deformation of the left and right front side members 11L and 11R such as the longitudinal bending deformation can be suppressed during a front collision test at a high velocity, and, as a consequence, insufficiency of the absorption of the impact energy can be suppressed.

Moreover, in the vehicle front structure 100, the plurality of first bumper brackets 50L and 50R and the left and right second bumper brackets 70L and 70R fastened to the bumper reinforcement 12 are in contact with the rear ends of the plurality of first brackets 30L and 30R, and the rear ends of the left and right second brackets 60L and 60R. With this configuration, the impact force in the vehicle front-and-rear direction, which is input from the rear ends of the plurality of first brackets 30L and 30R, and the rear ends of the left and right second brackets 60L and 60R, is transmitted to the bumper reinforcement 12, and the rotational moment applied to the first brackets 30L and 30R, and the second brackets 60L and 60R can be prevented from being transmitted to the bumper reinforcement 12. Because of this, in the vehicle front structure 100, the impact force from the front side or from the slanted front direction is received by the bumper reinforcement 12, and unexpected longitudinal bending deformation such as upward-bending deformation of the left and right front side members 11L and 11R can be suppressed, and, as a consequence, insufficiency of the absorption of the impact energy can be suppressed.

In addition, in the vehicle front structure 100, each of the first brackets 30L and 30R has the pocket portion 38 and the sheet metal bulk 40 housed in the pocket portion 38. With this configuration, a larger impact force as compared with a configuration without the sheet metal bulk 40 can be received by the bumper reinforcement 12, and transmitted to the left and right front side members 11L and 11R. Thus, the amount of ingression of the pendulum colliding body 90 can be further suppressed.

In addition, in the vehicle front structure 100, the center left and center right first brackets 30L and 30R are disposed symmetrically on the left and right sides, respectively between the center in the vehicle width direction and the left and right front side members 11L and 11R. With this configuration, the distance of ingression of the pendulum colliding body 90 which ingresses at a low position can be suppressed over a wide range in the vehicle with direction, with two first brackets 30L and 30R. In addition, in the pendulum test in which the pendulum colliding body 90 is collided with an offset to the side from the front, the distance of ingression of the pendulum colliding body 90 can be suppressed with the first brackets 30L and 30R.

Further, in the vehicle front structure 100, the plurality of first brackets 30L and 30R, and the left and right second brackets 60L and 60R are resin molded integrally with the longitudinal base member 20, and are attached to the bumper reinforcement 12 via the longitudinal base member 20. With this configuration, the plurality of first brackets 30L and 30r, the left and right second brackets 60L and 60R, and the longitudinal base member 20 can be manufactured in a simple manner. In addition, the first brackets 30L and 30R, and the left and right second brackets 60L and 60R can be attached in a short period of time.

In the above description, the left and right second brackets 60L and 60R are described to have longitudinal ribs 67 being disposed in the pocket portions 68, but the present disclosure is not limited to such a configuration. For example, similar to the first brackets 30L and 30R, the sheet metal bulk 40 may be disposed in the pocket portion 68. In this case, the rear end surfaces 46 of the left and right flanges 41B of the sheet metal bulk 40 are on the same plane as the rear end surfaces 66 of the side plates 61 of the left and right second brackets 60L and 60R, and the rear end surface 46 of the sheet metal bulk 40 and the rear end surface 66 of the side plate 61 form rear ends of the left and right second brackets 60L and 60R. In this configuration, the left and right second bumper brackets 70L and 70R are in contact with the rear end surface 66 of the side plate 61 and the rear end surface 46 of the flange 41B of the sheet metal bulk 40. With this configuration, a large impact force as compared with a configuration without the sheet metal bulk 40 can be transmitted to the left and right front side members 11L and 11R, and the distance of ingression of the pendulum colliding body 90 can be further suppressed. In addition, similar to the configuration described above, unexpected longitudinal bending deformation such as the upward-bending deformation of the left and right front side members 11L and 11R can be suppressed during the front collision test at a high velocity.

Moreover, in the above description, the vehicle front structure 100 is described to have two first brackets 30L and 30R at center left and center right, but the present disclosure is not limited to such a structure. For example, two or more first brackets 30 at each side, and a total of four or more first brackets 30, may be provided respectively between the center in the vehicle width direction and the left and right front side members 11L and 11R, in a symmetric manner on the left and right sides.

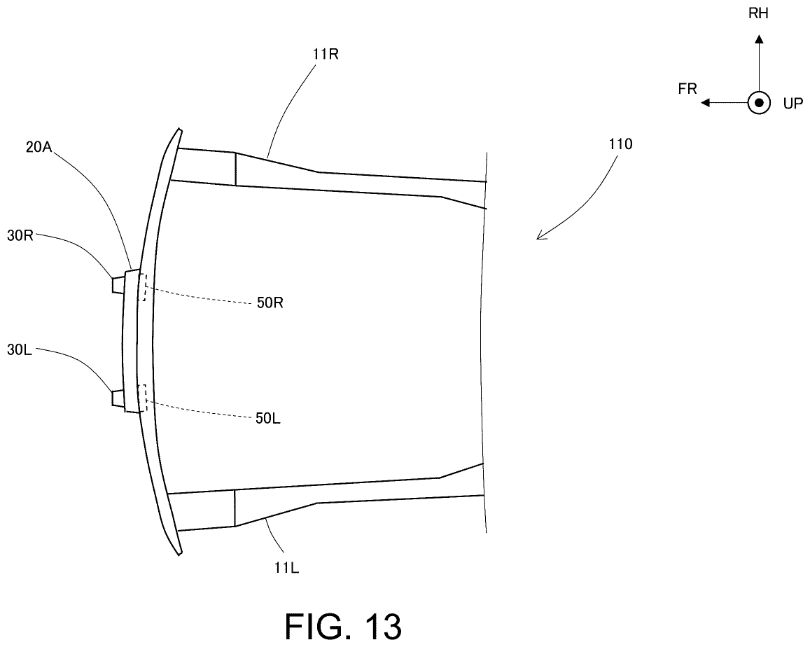

Next, with reference to FIG. 13, a vehicle front structure 110 according to another embodiment of the present disclosure will be described. Components identical with those of the vehicle front structure 100 described above with reference to FIGS. 1 to 12 are assigned the same reference numerals, and their descriptions will not be repeated.

As shown in FIG. 13, the vehicle front structure 110 differs from the vehicle front structure 100 already described in that the vehicle front structure 110 does not have the left and right second brackets 60L and 60R, and in that the vehicle front structure 110 has, in place of the longitudinal base member 20, a base member 20A which connects the center left and center right first brackets 30L and 30R in the vehicle width direction, at a center part in the vehicle width direction. The other structures are identical with those of the vehicle front structure 100 described above.

The base member 20A is a resin member which connects the center left and center right first brackets 30L and 30R in the vehicle width direction, at the center part in the vehicle width direction. A cross sectional shape or the like of the base member 20A is identical with that of the longitudinal base member 20 described above, and the base member 20A differs from the longitudinal base member 20 in that a length in the vehicle width direction is shorter.

The vehicle front structure 110 can suppress, with the plurality of first brackets 30L and 30R, the distance of ingression of the pendulum colliding body 90 which ingresses at a low position at a low velocity from the front side of the vehicle 200.

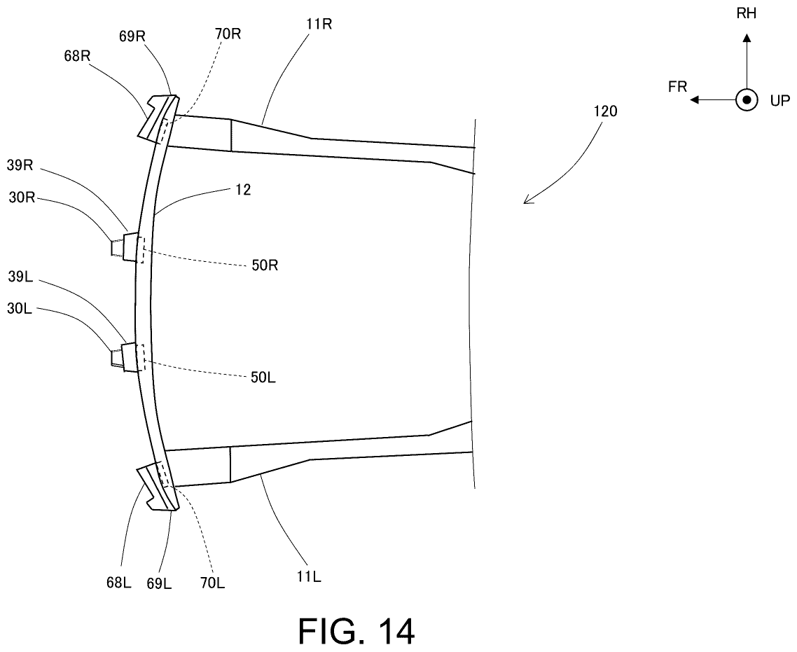

Next, with reference to FIG. 14, a vehicle front structure 120 according to another embodiment of the present disclosure will be described. Components identical with those of the vehicle front structure 100 described above with reference to FIGS. 1 to 12 are assigned the same reference numerals, and their descriptions will not be repeated.

The vehicle front structure 120 differs from the vehicle front structure 100 in that the vehicle front structure 120 has, in place of the longitudinal base member 20, partial base members 39L, 39R, 69L and 69R. The other structures are identical with those of the vehicle front structure 100 described above.

The partial base member 39L is a bracket for attaching the first bracket 30L to the front surface of the bumper reinforcement 12, and a cross sectional shape or the like thereof is identical to a part, of the longitudinal base member 20 described above, to which the first bracket 30L is connected. The partial base member 39R is symmetric on the left and right sides with the partial base member 39L. The partial base member 69L is a bracket for attaching the second bracket 60L to the front surface of the bumper reinforcement 12, and a cross sectional shape or the like thereof is identical with a part, of the longitudinal base member 20 described above, to which the second bracket 60L of the left and right ends are connected. The partial base member 69R is symmetric on the left and right sides with the partial base member 69L.

Similar to the vehicle front structure 100 described above, the vehicle front structure 120 can suppress the distance of ingression of the pendulum colliding body 90 which ingresses at a low position at a low velocity from the front side or from the slanted front direction of the vehicle 200, and can also suppress unexpected longitudinal bending deformation such as upward-bending deformation of the left and right front side members 11L and 11R during the front collision test at a high velocity.

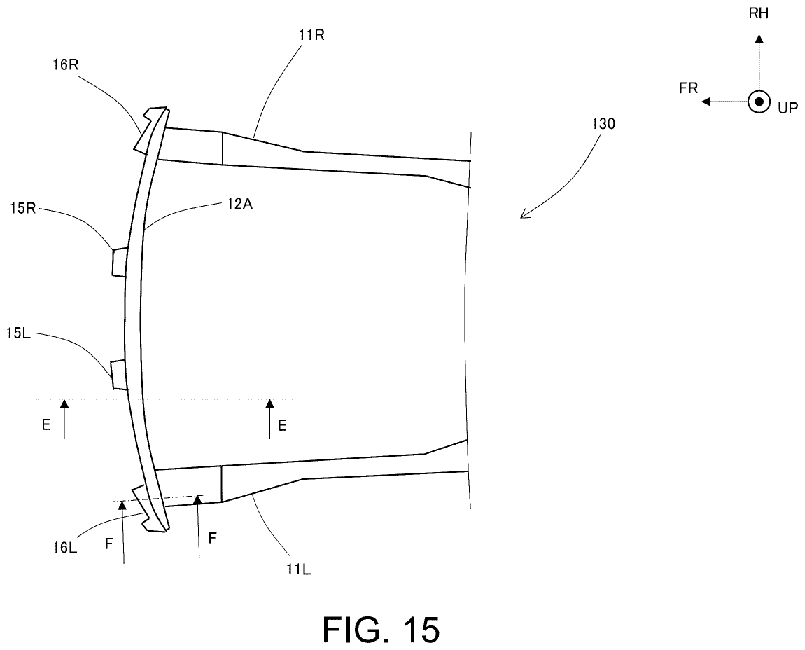

Next, with reference to FIGS. 15 to 17, a vehicle front structure 130 according to another embodiment of the present disclosure will be described. Components identical with those of the vehicle front structure 100 described above with reference to FIGS. 1 to 12 will be assigned the same reference numerals, and their descriptions will not be repeated.

As shown in FIG. 15, the vehicle front structure 130 includes the left and right front side members 11L and 11R, the bumper reinforcement 12, a plurality of first receiving portions 15L and 15R, and left and right second receiving portions 16L and 16R. The plurality of first receiving portions 15L and 15R, and the left and right second receiving portions 16L and 16R form a plurality of load receiving portions.

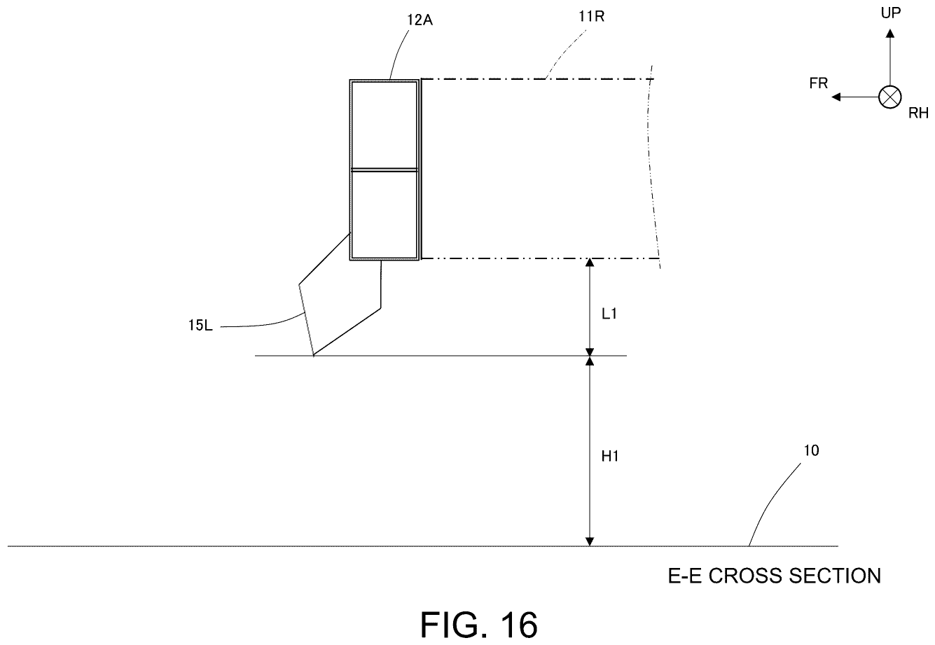

As shown in FIG. 15, the first receiving portions 15L and 15R are disposed symmetric on the left and right sides, respectively between the center in the vehicle width direction and the left and right front side members 11L and 11R, in such a manner so as not to overlap the left and right front side members 11L and 11R when viewed from the vehicle front side. As shown in FIG. 16, the center left first receiving portion 15L is formed integrally with the bumper reinforcement 12, and protrudes from the bumper reinforcement 12 toward the vehicle front side and the vehicle downward side. A shape of the first receiving portion 15L is similar to that of the first bracket 30L of the vehicle front structure 100 described above, and the first receiving portion 15L protrudes from the lower surface of the bumper reinforcement 12 by a length L1 downward in the vehicle up-and-down direction such that a height from the road surface 10 is a predetermined height H1. The center right first receiving portion 15R is symmetric on the left and right sides with the center left first receiving portion 15L.

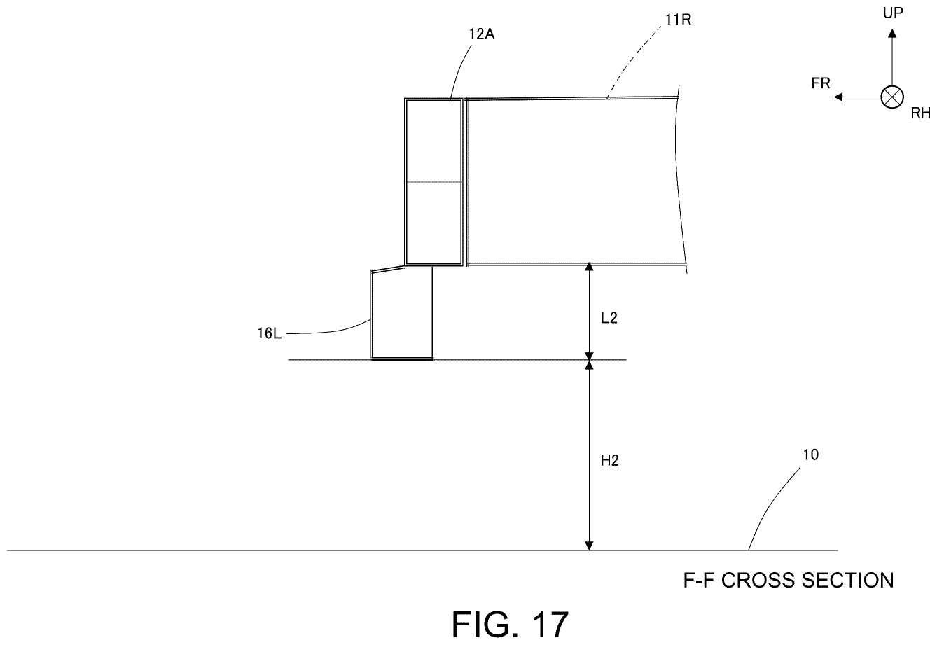

In addition, as shown in FIG. 15, the left and right second receiving portions 16L and 16R are provided respectively at left and right ends of the bumper reinforcement 12, in such a manner to respectively overlap the left and right front side members 11L and 11R when viewed from the vehicle front side. As shown in FIG. 17, the left second receiving portion 16L is formed integrally with the bumper reinforcement 12, and protrudes from the bumper reinforcement 12 on the vehicle front side and the vehicle downward side. A shape of the second receiving portion 16L is similar to that of the second bracket 60L of the vehicle front structure 100 described above, and the second receiving portion 16L protrudes from the lower surface of the bumper reinforcement 12 by a length L2 downward in the vehicle up-and-down direction, such that a height from the road surface 10 is a predetermined height H2. The right second receiving portion 16R is symmetric on the left and right sides with the left second receiving portion 16L.

The bumper reinforcement 12, the first receiving portions 15L and 15R, and the second receiving portions 16L and 16R may be formed integrally, for example, through casting.

The vehicle front structure 130 can suppress, with the plurality of first receiving portions 15L and 15R and the left and right second receiving portions 16L and 16R, the distance of ingression of the pendulum colliding body 90 which ingresses at a low position with a low velocity from the front side of the vehicle 200.

In the vehicle front structure 130, the first receiving portions 15L and 15R protrude more to the vehicle front side in relation to the second receiving portions 16L and 16R. Because of this, during the front collision test at a high velocity, described above with reference to FIGS. 11 and 12, the barrier 95 collides with the first receiving portions 15L and 15R. Because the first receiving portions 15L and 15R are disposed in such a manner so as not to overlap the left and right front side members 11L and 11R when viewed from the front side of the vehicle, a longitudinal bending moment which is input from the first receiving portions 15L and 15R protruding in the vehicle downward direction to the left and right front side members 11L and 11R can be suppressed. With this configuration, the vehicle front structure 130 can suppress the longitudinal bending deformation of the left and right front side members 11L and 11R during the front collision test at a high velocity.

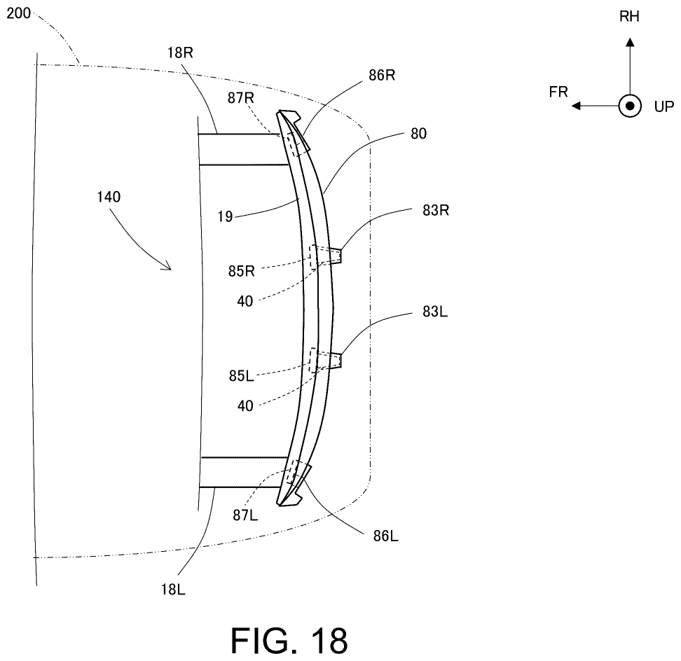

Next, with reference to FIG. 18, a vehicle rear structure 140 which is another embodiment of the vehicle body structure according to the present disclosure will be described.

As shown in FIG. 18, the vehicle rear structure 140 comprises left and right rear side members 18L and 18R, a rear bumper reinforcement 19, a rear longitudinal base member 80, a plurality of rear first brackets 83L and 83R, left and right rear second brackets 86L and 86R, a plurality of rear first bumper brackets 85L and 85R, and left and right rear second bumper brackets 87L and 87R.

The rear side members 18L and 18R are skeletal members which are disposed at left and sides of the rear part of the vehicle 200, and which extend in the vehicle front-and-rear direction. The rear bumper reinforcement 19 is a member which is connected to rear ends of the left and right rear side members 18L and 18R, and which extends in the vehicle width direction.

The rear longitudinal base member 80, the plurality of rear first brackets 83L and 83R, the left and right rear second brackets 86L and 86R, the plurality of rear first bumper brackets 85L and 85R, and the left and right rear second bumper brackets 87L and 87R are respectively symmetric on the front and rear sides with the longitudinal base member 20, the plurality of first brackets 30L and 30R, the left and right second brackets 60L and 60R, the plurality of first bumper brackets 50L and 50R, and the left and right second bumper brackets 70L and 70R, of the vehicle front structure 100 described above.

The rear first brackets 83L and 83R, and the rear second brackets 86L and 86R are resin members which protrude from the rear longitudinal base member 80 in this vehicle rear side and the vehicle downward side. In other words, the rear first brackets 83L and 83R, and the rear second brackets 86L and 86R protrude from the rear longitudinal base member 80 toward the outer side in the vehicle front-and-rear direction, and downward in the vehicle up-and-down direction. In addition, the rear first bumper brackets 85L and 85R are in contact with front ends of the rear first brackets 83L and 83R, and the left and right second bumper brackets 87L and 87R are in contact with front ends of the left and right rear second brackets 86L and 86R. Here, the front ends of the rear first brackets 83L and 83R, and the front ends of the rear second brackets 86L and 86R form ends, at an inner side in the vehicle front-and-rear direction, of the rear first brackets 83L and 83R, and ends, at an inner side in the vehicle front-and-rear direction, of the rear second brackets 86L and 86R.

Similar to the vehicle front structure 100 described above, the vehicle rear structure 140 can suppress the amount of ingression of the pendulum colliding body 90 which ingresses at a low position with a low velocity from the rear side or from the slanted rear direction of the vehicle 200. In addition, the vehicle rear structure 140 can suppress unexpected deformation of the left-and-right rear side members 18L and 18R during a rear collision test at a high velocity, and can consequently suppress insufficiency of absorption of the impact energy by the left and right rear side members 18L and 18R.

1. A vehicle body structure comprising:
left and right skeletal members that are disposed respectively on left and right sides of a vehicle, and that extend in a vehicle front-and-rear direction; and
a bumper reinforcement that is connected to an end, on one side in the vehicle front-and-rear direction, of each of the skeletal members, and that extends in a vehicle width direction, wherein
the bumper reinforcement comprises a plurality of load receiving portions which protrude toward an outer side in the vehicle front-and-rear direction, and downward in a vehicle up-and-down direction.

2. The vehicle body structure according to claim 1, wherein
the plurality of load receiving portions include a plurality of first receiving portions disposed at positions which do not overlap the left and right skeletal members when viewed in the vehicle front-and-rear direction.

3. The vehicle body structure according to claim 2, wherein
the plurality of load receiving portions include left and right second receiving portions disposed at positions respectively overlapping the left and right skeletal members when viewed in the vehicle front-and-rear direction.

4. The vehicle body structure according to claim 2, wherein
the plurality of first receiving portions are a plurality of first brackets which are separate members from the bumper reinforcement, and
the plurality of first brackets are attached to the bumper reinforcement, and protrude toward an outer side in the vehicle front-and-rear direction and downward in the vehicle up-and-down direction, in relation to the bumper reinforcement.

5. The vehicle body structure according to claim 4, wherein
the plurality of first brackets are disposed symmetrically on left and right sides, respectively between a center in the vehicle width direction and the left and right skeletal members.

6. The vehicle body structure according to claim 5, further comprising:
a base member that is attached at an outer side, in the vehicle front-and-rear direction, of the bumper reinforcement, and that extends in the vehicle width direction, to connect the plurality of first brackets in the vehicle width direction, wherein
the plurality of first brackets are attached to the bumper reinforcement via the base member.

7. The vehicle body structure according to claim 4, further comprising:
a plurality of first bumper brackets that are fastened to the bumper reinforcement, and that have tips which are in contact with ends, at an inner side in the vehicle front-and-rear direction, of the plurality of first brackets.

8. The vehicle body structure according to claim 5, further comprising:
a plurality of first bumper brackets that are fastened to the bumper reinforcement, and that have tips which are in contact with ends, at an inner side in the vehicle front-and-rear direction, of the plurality of first brackets.

9. The vehicle body structure according to claim 6, further comprising:
a plurality of first bumper brackets that are fastened to the bumper reinforcement, and that have tips which are in contact with ends, at an inner side in the vehicle front-and-rear direction, of the plurality of first brackets.

10. The vehicle body structure according to claim 7, wherein
the first bracket comprises an open-box type pocket portion which is attached at an outer side, in the vehicle front-and-rear direction, of the bumper reinforcement, and that has an inner side in the vehicle front-and-rear direction opened, and a sheet metal bulk housed in the pocket portion, and
the first bumper bracket is fastened to the bumper reinforcement, and has a tip which is in contact with an end, at an inner side in the vehicle front-and-rear direction, of the pocket portion, and an end, at an inner side in the vehicle front-and-rear direction, of the sheet metal bulk.

11. The vehicle body structure according to claim 3, wherein
the plurality of first receiving portions are a plurality of first brackets which are separate members from the bumper reinforcement,
the plurality of first brackets are attached to the bumper reinforcement, and protrude toward an outer side in the vehicle front-and-rear direction, and downward in the vehicle up-and-down direction, in relation to the bumper reinforcement,
the left and right second receiving portions are left and right second brackets which are separate members from the bumper reinforcement, and
the left and right second brackets are attached to the bumper reinforcement, and protrude toward an outer side in the vehicle front-and-rear direction, and downward in the vehicle up-and-down direction, in relation to the bumper reinforcement.

12. The vehicle body structure according to claim 11, wherein
the plurality of first brackets are disposed symmetrically on left and right sides, respectively between a center in the vehicle width direction and the left and right skeletal members.

13. The vehicle body structure according to claim 12, further comprising:
a longitudinal base member that is attached at an outer side, in the vehicle front-and-rear direction, of the bumper reinforcement, and that extends in the vehicle width direction, to connect the plurality of first brackets and the left and right second brackets in the vehicle width direction, wherein
the plurality of first brackets and the left and right second brackets are attached to the bumper reinforcement via the longitudinal base member.

14. The vehicle body structure according to claim 11, further comprising:
a plurality of first bumper brackets that are fastened to the bumper reinforcement, and that have tips which are in contact with ends, at an inner side in the vehicle front-and-rear direction, of the plurality of first brackets; and
left and right second bumper brackets that are fastened to the bumper reinforcement, and that have tips which are in contact with ends, at an inner side in the vehicle front-and-rear direction, of the left and right second brackets.

15. The vehicle body structure according to claim 12, further comprising:
a plurality of first bumper brackets that are fastened to the bumper reinforcement, and that have tips which are in contact with ends, at an inner side in the vehicle front-and-rear direction, of the plurality of first brackets; and
left and right second bumper brackets that are fastened to the bumper reinforcement, and that have tips which are in contact with ends, at an inner side in the vehicle front-and-rear direction, of the left and right second brackets.

16. The vehicle body structure according to claim 13, further comprising:
a plurality of first bumper brackets that are fastened to the bumper reinforcement, and that have tips which are in contact with ends, at an inner side in the vehicle front-and-rear direction, of the plurality of first brackets; and
left and right second bumper brackets that are fastened to the bumper reinforcement, and that have tips which are in contact with ends, at an inner side in the vehicle front-and-rear direction, of the left and right second brackets.

17. The vehicle body structure according to claim 14, wherein
one or both of the first bracket and the second bracket comprises an open-box type pocket portion which is attached at an outer side, in the vehicle front-and-rear direction, of the bumper reinforcement, and which has an inner side in the vehicle front-and-rear direction opened, and a sheet metal bulk housed in the pocket portion, and
one or both of the first bumper bracket and the second bumper bracket is fastened to the bumper reinforcement, and has a tip which is in contact with an end, at an inner side in the vehicle front-and-rear direction, of the pocket portion, and an end, at an inner side in the vehicle front-and-rear direction, of the sheet metal bulk.

18. The vehicle body structure according to claim 3, wherein
the plurality of first receiving portions and the left and right second receiving portions protrude downward in the vehicle up-and-down direction to a predetermined ground height.

19. The vehicle body structure according to claim 11, wherein
the plurality of first brackets and the left and right second brackets protrude downward in the vehicle up-and-down direction to a predetermined ground height.
